(19) United States
(12) Patent Application Publication
(10) Pub. No.: US 2024/0342646 A1
(43) Pub. Date: Oct. 17, 2024

(54) SYSTEM, METHOD, AND DEVICE FOR SOLAR FLUID HARVESTING ENGINE

(71) Applicant: Microsoft Technology Licensing, LLC, Redmond, WA (US)

(72) Inventors: Winston Allen SAUNDERS, Seattle, WA (US); Eric C. PETERSON, Woodinville, WA (US); Ruslan NAGIMOV, Redmond, WA (US)

(21) Appl. No.: 18/135,589

(22) Filed: Apr. 17, 2023

(51) Int. Cl. B01D 53/26; B01D 53/04; F16M 11/20; F24S 10/80; F24S 50/80; H02N 2/18

(52) U.S. Cl. CPC B01D 53/261; B01D 53/0438; F16M 11/2021; F24S 10/80; F24S 50/80; H02N 2/186; B01D 2257/80; B01D 2259/40098

(57) ABSTRACT

A device for harvesting ambient fluid includes a cool area and a hot area. The device includes an absorption material configured to absorb ambient fluid. The device includes a means for moving the absorption material between the hot area and the cool area based on a weight differential of the absorption material.

### CROSS-REFERENCE TO RELATED APPLICATIONS

N/A

### BACKGROUND

In many regions of the world, it can be difficult to obtain reliable and clean sources of water. This may be in part due to a scarcity in water sources such as ground water, surface water, or rainwater, as well as inadequate methods of collection and storage. In many regions, however, water is present to at least some degree in the ambient environment in the form of water vapor. By harvesting water vapor from the air, a reliable and clean water source may be provided in areas where access to water has typically been limited. Thus, ambient water harvesting can be beneficial to the many communities worldwide facing the critical issue of having clean water.

Conventional ambient water harvesting techniques, however, typically involve the use of specialized devices such as condensers, compressors, pumps, motors, heaters, and the like in order to convert ambient water vapor into usable liquid water. Conventional devices may also typically require a significant amount of energy to operate. Such device may therefore be prohibitively expensive and difficult to implement in many communities, due to their upfront cost and complexity, as well as the energy resources required for operation. Thus, improved devices for ambient water harvesting may be advantageous over conventional techniques.

### SUMMARY

In some embodiments, a device for harvesting ambient fluid includes a cool area and a hot area. The device includes an absorption material configured to absorb ambient fluid. The device includes a means for moving the absorption material between the cool area and the hot area based on a weight differential of the absorption material.

In some embodiments, a method of harvesting ambient fluid includes, in a first area, absorbing the ambient fluid into an absorption material as absorbed ambient fluid. The method includes moving the absorption material between the first area and a second area based on a weight differential. The method includes, in the second area, desorbing at least a portion of the absorbed ambient fluid from the absorption material as desorbed ambient fluid. The method includes condensing at least a portion of the desorbed ambient fluid as condensed ambient fluid.

In some embodiments, a system for generating energy includes a first area including a thermal shield having a film transparent to electromagnetic energy with wavelengths of 10-20 micrometers and reflective to at least 95% of visible light. The system includes a second area including a solar powered heater. The system includes an absorption material for reversibly absorbing water vapor from an ambient environment. The system includes an actuator configured to move the absorption material based on an absorption of the water vapor into the absorption material in the first area and a desorption of the water vapor from the absorption material in the second area. The system includes a motive device configured to generate an energy output based on the movement of the actuator.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1 is a schematic representation of a fluid harvesting device, according to at least one embodiment of the present disclosure;

FIG. 2-1 is a perspective view of an absorption material container, according to at least one embodiment of the present disclosure;

FIG. 2-2 is a perspective view of an absorption material container, according to at least one embodiment of the present disclosure;

FIG. 3 is a side view of a fluid harvesting device, according to at least one embodiment of the present disclosure;

FIG. 4 is a side view of a fluid harvesting device, according to at least one embodiment of the present disclosure;

FIG. 5 is a side view of a fluid harvesting device, according to at least one embodiment of the present disclosure;

FIG. 6 is a perspective cutaway view of a fluid harvesting device, according to at least one embodiment of the present disclosure;

FIG. 7 is a perspective view of a fluid harvesting device, according to at least one embodiment of the present disclosure;

FIG. 8 is a perspective view of a fluid harvesting device, according to at least one embodiment of the present disclosure;

FIG. 9 is a perspective view of a fluid harvesting device, according to at least one embodiment of the present disclosure;

FIG. 10 is a schematic representation of a fluid harvesting device, according to at least one embodiment of the present disclosure; and

FIG. 11 illustrates a flow diagram for a method or a series of acts for harvesting ambient fluid, according to at least one embodiment of the present disclosure.

### DETAILED DESCRIPTION

The present disclosure is generally related to a fluid harvesting device. In some embodiments, the fluid harvesting device includes an absorption material such as a hydrogel, desiccant, or aerogel configured to absorb fluid from an ambient environment (e.g., out of the air). For example, the absorption material may be treated with a deliquescent salt to enhance absorption. The absorption material may also be configured to release or desorb the fluid. The ability and/or effectiveness of the absorption material to absorb or desorb the ambient fluid may be based on and/or may be affected by a temperature of the absorption material. For example, the absorption material at cooler temperatures may facilitate or may result in the absorption material absorbing ambient fluid, and the absorption material at warmer temperatures may facilitate or may result in the absorption material releasing or desorbing the fluid.

The fluid harvesting device may take advantage of this effect by subjecting or exposing the absorption material to both hot and cold temperatures. For example, the fluid harvesting device may include a cool area and a hot area. A passive radiative cooling film may be implemented to cool the cool area by radiating heat to the upper atmosphere while reflecting thermal energy from the sun (e.g., reflecting visible light). A solar heater may be implemented to heat the hot area by absorbing thermal energy from the sun. In this way, the fluid harvesting device may provide both cool and hot environments in order to facilitate the absorbing and desorbing mechanisms of the absorption material.

The fluid harvesting device may move the absorption material between the cool and hot areas. A lever mechanism and/or a rotary mechanism may be implemented to move the absorption material based on a weight differential of the absorption material and/or based on gravity. For example, as the absorption material takes on ambient fluid, it may become heavier. Similarly, as the absorption material releases fluid it may become lighter. The cool area (where absorption takes place) may be at least partially located above or at a vertically higher position than the hot area (where desorption takes place). The heavier absorption material in the cool area may be driven downwards due to gravity toward the hot area.

The hot area may additionally include a condenser for condensing the fluid released by the absorption material in the hot area. The condenser may include a passive radiative cooling film in order to provide one or more cool surfaces for the fluid to condense on. The condensed fluid may be collected, and in this manner the fluid harvesting device may harvest fluid from the ambient environment.

In this way, the fluid harvesting device may operate passively, or without any external energy input (such as electricity) to, for example, cool the cool area, heat the hot area, condense the desorbed fluid, or move the absorption material between the areas. In some embodiments, the fluid harvesting device includes a motive device to convert the mechanical motion of the fluid harvesting device into an energy output. For example, a motor or generator may be implemented to generate an electrical current. The motive device may not be used to, for example, drive a movement of the absorption material between the cool and hot areas. In this way, the fluid harvesting device not only operates without any energy consumption, but may have a net positive energy output.

As illustrated in the foregoing discussion and as will be discussed in further detail herein, the present disclosure utilizes a variety of terms to describe features and advantageous of the methods, systems, and devices described herein. Some of these terms will be discussed in further detail below.

As used herein, the term “fluid” or “ambient fluid” may refer to any fluid in either a liquid or gaseous state that may be present in and/or around a fluid harvesting device. For example, fluid may refer to water vapor present in ambient air. Fluid may refer to water vapor that has evaporated and/or desorbed from an absorption material. In another example, fluid may refer to liquid water that has been absorbed to an absorption material. Fluid may refer to liquid water that has condensed in a condenser and/or been collected at a collection point. Fluid may refer to any other substance in either liquid or gaseous form which may be harvested through the techniques described herein.

As used herein, the term “absorb” or absorbed” may refer to the act, process, or effect of a material or substance taking in, capturing, imbibing, or otherwise retaining a fluid. For example, absorb may refer to a material absorbing a fluid. In another example, absorb may refer to a material adsorbing a fluid. Absorbing may refer to any other mechanism (e.g., mechanical, chemical, biological, etc.) by which fluid may be brought in and contained, for example, by an absorption material. Similarly, the term “desorb” may refer to the reverse process of “absorb,” or may refer to the act, process, or effect of a material or substance releasing, emitting, losing, or otherwise giving up fluid. For example, desorbing may apply to an absorbent material, an adsorbent material, or any other material.

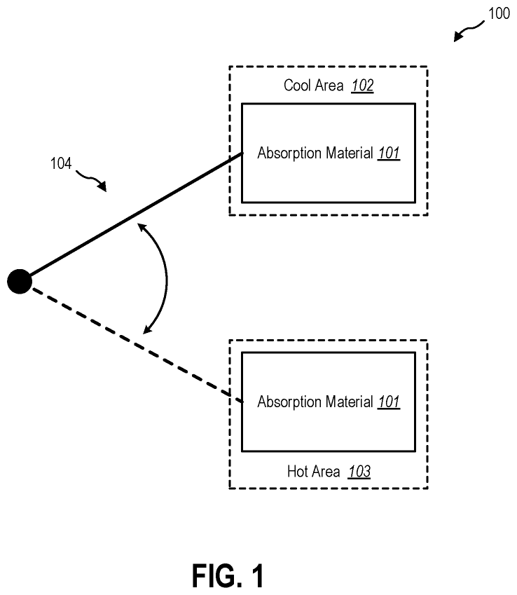

FIG. 1 is a schematic representation of a fluid harvesting device 100, according to at least one embodiment of the present disclosure. In some embodiments, the fluid harvesting device 100 includes an absorption material 101. The absorption material 101 may be a material or substance that is configured to absorb a fluid, for example, from or out of an ambient environment. In some embodiments, the absorption material 101 is configured to releases fluid or desorb the fluid it previously absorbed. In this way, the absorption material 101 may reversibly take in and/or capture fluid in order to facilitate the fluid harvesting techniques described herein.

In some embodiments, the fluid harvesting device 100 includes a cool area 102. The cool area 102 may be a first area of the fluid harvesting device 100. The cool area 102 may be an area that is cooled or chilled to at least some degree. For example, the cool area 102 may have a temperature below an atmospheric temperature, or below a temperature of an ambient environment. In some embodiments the cool area 102 has a temperature below that of a hot area 103 (as will be discussed herein). The cool area 102 may facilitate the absorption material 101 absorbing ambient fluid. For example, the absorption material 101 may be configured to absorb fluid (e.g., more efficiently or more effectively) at cooler temperatures, and the cool area 102 may exhibit and/or may facilitate exposing the absorption material 101 to cooler temperatures. In this way, the absorption material 101 may absorb ambient fluid, for example, in the cool area 102.

In some embodiments, the fluid harvesting device 100 includes a hot area 103. The hot area 103 may be a second area of the fluid harvesting device 100. The hot area 103 may be an area that is heated or warmed to at least some degree. For example, the hot area 103 may have a temperature above an atmospheric temperature, or above a temperature of an ambient environment. In some embodiments, the hot area 103 has a temperature above that of the cool area 102. The hot area 103 may facilitate the absorption material 101 desorbing absorbed fluid (e.g., previously absorbed ambient fluid). For example, the absorption material 101 may be configured to release fluid (e.g., more efficiently or more effectively) at warmer temperatures, and the hot area 103 may exhibit and/or may facilitate exposing the absorption material 101 to warmer temperatures. In this way, the absorption material 101 may desorb fluid, for example, in the hot area 103.

In some embodiments, the fluid harvesting device 100 includes positioner 104. The positioner 104 may position the absorption material 101 in the cool area 102 and the hot area 103 and/or may move the absorption material 101 between the cool area 102 and the hot area 103. For example, the positioner 104 may move (e.g., periodically or continually) the absorption material 101 from the cool area 102 to the hot area 103 and vice versa. This may facilitate collecting and/or harvesting fluid from the ambient environment. For example, the positioner 104 may position the absorption material 101 in the cool area 102 where the absorption material 101 may absorb ambient fluid. The positioner 104 may then move and/or position the absorption material 101 in the hot area 103, where the absorption material 101 may release the absorbed ambient fluid. The released fluid may then be collected, as will be discussed herein (e.g., in the hot area or in association with the hot area). In this way, the fluid harvesting device 100 may remove and collect fluid (e.g., water) from an ambient environment.

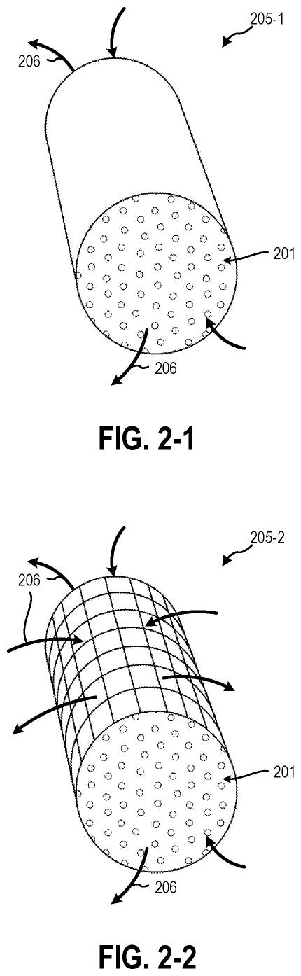

FIG. 2-1 is a perspective view of an absorption material container 205-1, according to at least one embodiment of the present disclosure. FIG. 2-2 is a perspective view of an absorption material container 205-2, according to at least one embodiment of the present disclosure. The containers 205-1 and 205-2 (each being an embodiment of a container 205) may contain or may house an absorption material 201 (such as the absorption material 101 of FIG. 1).

In some embodiments, the absorption material 201 absorbs or takes in fluid 206. For example, the absorption material 201 may absorb the fluid 206 from an ambient environment, such as from the air. In another example, the absorption material 201 may absorb the fluid 206 by coming into contact with the fluid 206, such as a liquid phase of the fluid 206. In some embodiments, the fluid 206 is water vapor that the absorption material 201 absorbs out of the air. The fluid 206 may be carbon dioxide, hydrogen, nitrogen, any other fluid (e.g., in a gas phase), and combinations thereof. In some embodiments, the absorption material 201 absorbs the fluid 206 as a liquid phased of the fluid 206. For example, the fluid 206 may be present in the ambient environment as a gas, and may condense as it is absorbed. In some embodiments, the absorption material 201 absorbs the fluid 206 as a gas phase of the fluid 206.

In some embodiments, the absorption material 201 includes a material or substrate that has an electrostatic attraction to the fluid 206, or the fluid 206 may be electrostatically attracted to the substrate of the absorption material 201. For example, the absorption material 201 may be fluid-philic (e.g., hydrophilic). In some embodiments, the absorption material 201 includes a salt (e.g., a deliquescent salt), such as calcium chloride or any other salt. For example, the salt may be intercalated within the absorption material 201 (e.g., within a matrix of the substrate of the absorption material 201). This may facilitate the absorption material taking in and/or removing more of the fluid 206 from the ambient environment. In this way, the absorption material 201 may be configured to absorb and/or take in the fluid 206.

In some embodiments, the absorption material 201 is configured to desorb (e.g., expel) the fluid 206. For example, the absorption material 201 may desorb the fluid 206 to an ambient environment. In some embodiments, the fluid 206 is water vapor that the absorption material 201 desorbs into air. In some embodiments the absorption material 201 desorbs the fluid 206 as a gas phase of the fluid 206. In some embodiments, the absorption material 201 desorbs the fluid 206 as a liquid phase of the fluid 206. In this way, the absorption material 201 may reversibly capture (e.g., absorb and desorb) the fluid 206. In some embodiments, the absorption material 201 is non-toxic and/or does not contaminate the fluid 206 such that the fluid harvested by the fluid harvesting techniques described herein may be potable and/or adequate for human consumption.

In some embodiments, the absorption material 201 is configured to absorb the fluid 206 from the ambient environment in response to (e.g., more efficiently and/or more effectively based on) cooler temperatures and/or a temperature decrease. In this way, the temperature of the absorption material 201 may be lowered and/or the absorption material 201 may be exposed or subjected to cooler temperatures in order to facilitate absorbing the fluid 206 into the absorption material. The absorption material 201 may also be configured to desorb or expel the fluid 206 (e.g., that was previously absorbed) in response to (e.g., more efficiently and/or more effectively based on) warmer temperatures and/or a temperature increase. In this manner, the temperature of the absorption material 201 may be increased and/or the absorption material 201 may be exposed or subjected to warmer temperature in order to facilitate desorbing the fluid 206 from the absorption material. The reversible absorption mechanism of the absorption material 201 in this way may facilitate the fluid harvesting methods discussed herein.

In accordance with at least one embodiment of the present disclosure, the absorption material 201 is a hydrogel. For example, the absorption material 201 may be configured for absorbing water vapor from the ambient environment. The absorption material 201 may be a natural, synthetic, or semi-synthetic hydrogel and combinations thereof. The absorption material 201 may exhibit a homo-polymer, co-polymer, or semi-interpenetrating network, and combinations thereof. The absorption material 201 may have an amorphous, crystalline, or semi-crystalline structure, and combinations thereof. The absorption material may include salts such as CaCl₂), to enhance liquid retention and/or absorption. The absorption material 201 may be any type of hydrogel or aerogel in accordance with that discussed herein. In this way, the absorption material 201 may facilitate removing water vapor from the ambient environment.

As mentioned above, the absorption material 201 may be contained in or housed in the container 205. The container 205 may hold the absorption material 201 while also providing (at least partly) exposure of the absorption material 201 to the environment. This may facilitate the absorption material 201 absorbing and/or desorbing the fluid 206. In some embodiments, the container 205 is a partially enclosed volume with one or more open ends. For example, the container 205 may include a surface that is substantially cylindrical. The container 205 may have a solid cylindrical surface with one or both ends of the cylindrical surface open and/or exposed, such as container 205-1. As shown, this may facilitate the fluid 206 absorbing into and/or desorbing from the absorption material 201 through the open ends of the cylinder. The container 205 may have and/or may incorporate any other shape, such as a sphere, rectangle, square, circle, oval, triangle, polygon, any other shape, and combinations thereof. The container 205 may include one or more holes, openings, passages, or any other means for allowing the exposure of the absorption material 201 to the fluid 206, and combinations thereof. For example, as shown in FIG. 2-2, one or more surfaces of the container 205-2 may be at least partially made of or may include a mesh, matrix, lattice, screen, netting, or any other structure for allowing the fluid 206 to pass through and/or exposure of the absorption material 201 to the fluid 206, and combinations thereof. This may be in addition to, or in place of, one or more open ends of the container 205-2. In some embodiments, the structure of the container may be configured to optimize the surface to volume ratio of the absorption material. In this way, the container 205 (e.g., container 205-1 and/or container 205-2) may hold the absorption material 201 and may facilitate the fluid 206 being absorbed to and/or desorbed from the absorption material 201.

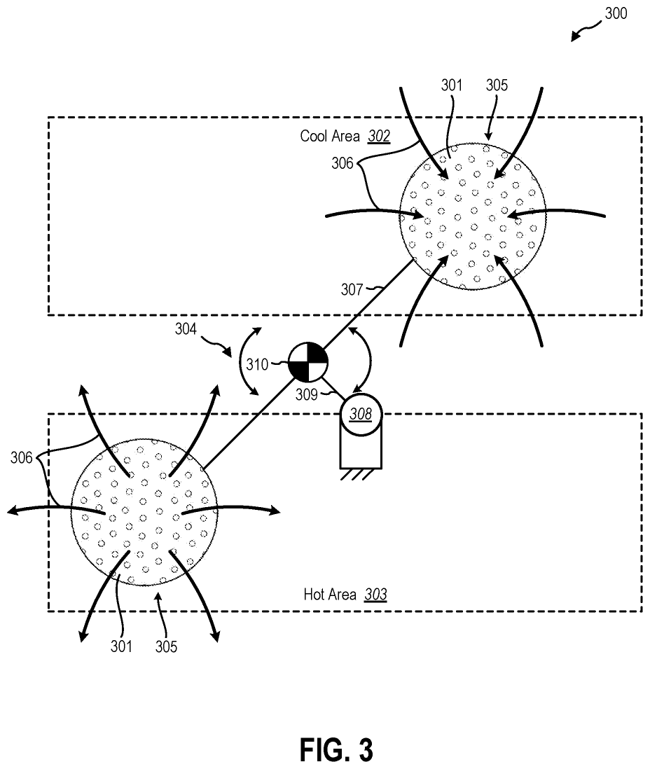

FIG. 3 is a side view of a fluid harvesting device 300, according to at least one embodiment of the present disclosure. In some embodiments, the fluid harvesting device 300 includes an absorption material 301 contained within one or more containers 305.

As discussed herein, the absorption material 301 may reversibly capture a fluid 306, for example, from an ambient atmosphere. In some embodiments, the fluid harvesting device 300 includes a cool area 302 and a hot area 303 in order to facilitate absorption and/or desorption of the fluid 306 by the absorption material 301. For example, the absorption material 301 being positioned in the cool area 302 may improve and/or enhance the absorption of the fluid 306 to the absorption material 301. The absorption material 301 being positioned in the hot area 303 may improve and/or enhance the desorption of the fluid 306 from the absorption material 301. In some embodiments, the cool area 302 is positioned (at least partially) above the hot area 303. For example, at least a portion of the cool area 302 may be located vertically higher than at least a portion of the hot area 303. In this way, the absorption material 301 may absorb and/or desorb the fluid 306 (e.g., or an absorption and/or desorption of the fluid 306 may be improved and/or enhanced) based on the absorption material 301 being positioned in either the cool area 302 or the hot area 303.

In some embodiments, the fluid harvesting device 300 positions the absorption material 301 in the cool area 302 and/or the hot area 303, or moves the absorption material 301 between the cool area 302 and the hot area 303. For example, the fluid harvesting device 300 may include an actuator 304. The actuator 304 may move (e.g., periodically or continually) one or more of the containers 305 between the cool area 302 and the hot area 303 to facilitate harvesting the fluid 306 from the ambient environment. In some embodiments, the actuator 304 is mechanically driven, for example, by an exterior motor or other motive input device to move the absorption material 301. In some embodiments, the actuator 304 is not mechanically driven by any motive input device, but operates and/or functions based on gravity alone, such as by a weight differential as discussed herein.

The actuator 304 operating and/or moving without a motor (e.g., the movement of the actuator 304 not being driven with and/or by a motor) does not exclude the implementation of one or more motors (or motor-driven components) operating and/or functioning in one or more other components and/or processes of the fluid harvesting device 300. In other words, the fluid harvesting device 300 may incorporate an external energy input such as electricity (e.g., to drive a motor) in one or more components of the fluid harvesting device 300 apart and/or independent of the actuator 304 operating without any external energy input (e.g., without electricity and/or a motor).

In some embodiments, the actuator 304 includes a lever 307. The lever 307 may be balanced and/or may pivot about a fulcrum 308. One or more containers 305 may be attached at one or more ends of the lever 307. The actuator 304 and the containers 305 may be configured such that pivoting the lever 307 about the fulcrum 308 moves the one or more containers 305 (and the absorption material 301) between the cool area 302 and the hot area 303. As will be discussed herein, a predetermined point of balance associated with the absorption material (e.g., between a full state and an empty state) may determine an overall fluid harvesting speed and/or frequency.

As discussed herein, the absorption material 301 is configured to absorb the fluid 306. In some embodiments, the absorption material 301 absorbs the fluid 306 while it is in the cool area 302. As mentioned above, the cool area 302 may be at least partially located vertically higher than the hot area 303. As the absorption material 301 absorbs the fluid 306, the absorption material 301 (and the container 305) may become heavier. For example, in some embodiments, the absorption material 201 takes in up to 2, 4, 5, 10, 50, or 100 times its weight in the fluid 206, and the container 305 may accordingly increase in weight. This increase in weight may cause an imbalance in the lever 307, and the container 305 may accordingly have a tendency to fall or travel down from the cool area 302 to the hot area 303 by the lever 307 pivoting about the fulcrum 308. Similarly, as discussed herein, the absorption material 301 is configured to desorb the fluid 306. In some embodiments, the absorption material 301 desorbs the fluid 306 while it is in the hot area 303. As the absorption material 301 desorbs the fluid 306, the absorption material 301 (and the container 305) may become lighter. This decrease in weight may cause an imbalance in the lever 307, and the container 305 may accordingly have a tendency to rise or travel up from the hot area 303 to the cool area 302 by the lever 307 pivoting about the fulcrum 308. In this way, the actuator 304 may be driven by gravity based on a weight differential between the absorption material 301 in both loaded (e.g., at least partially full or saturated with the fluid 306) and unloaded (e.g., at least partially empty of the fluid 306) states. The one or more containers 305 may, in this way, move between the cool area 302 and the hot area 303 cyclically based on a repeated absorption and desorption of the fluid 306 by the absorption material 301.

In some embodiments, one or more containers 305 are connected to the lever 307 of the actuator 304. For example, one or more containers 305 may be connected to one side or one end of the lever 307. The lever 307 may have a counterweight or counterbalance at an opposite end of the lever 307 from the one or more containers 305. The counterweight may be configured and positioned (e.g., a distance from the fulcrum) such that when the absorption material 301 becomes full, loaded, or increases to a threshold weight (e.g., due to absorption in the cool area 302), the lever 307 pivots about the fulcrum 308 and the one or more containers 305 fall downwards to the hot area 303. The counterweight may be configured and positioned such that when the absorption material 301 becomes empty, unloaded, or decreases to a threshold weight (e.g., due to desorption in the hot area 303) the lever 307 pivots about the fulcrum 308 and the one or more containers 305 rise upwards to the cool area 302. In another example, one or more containers 305 may be connected to opposite sides or opposite ends of the lever 307. For example, one end of the lever 307 (and one or more containers 305 positioned on that end) may be positioned in the cool area 302 and the other end of the lever 307 (and one or more containers 305 positioned on that end) may be positioned in the hot area 303. As the weights of the containers 305 change (e.g., based on absorption and/or desorption), the lever 307 may become imbalanced and may pivot about the fulcrum, thereby moving each container 305 from the cool area 302 to the hot area 303 or vice versa.

In this way, the actuator 304 (and more specifically the lever 307) may be a bistable mechanism, or a bistable lever, and may be positionable between one of two positions. For example, the actuator 304 may facilitate moving the one or more containers 305 based on a weight differential between the loaded (e.g., full) and unloaded (e.g., empty) states of the absorption material 301. Also in this way, the actuator 304 may move the one or more containers 305 naturally, automatically, or without any external energy input (not including solar energy input to heat the hot area 303 as will be discussed herein) such as electricity, wind energy, gasoline or other fuels, etc.

In some embodiments, the lever 307 pivots about its center of mass 310 (or center of gravity). For example, the fulcrum 308 may be located at the center of mass 310 of the lever 307. This may correspond with any unequal distribution of weight (e.g., weight differential) between the ends of the lever 307 (e.g., the containers 305 positioned on the ends of the lever 307) causing the lever 307 to pivot between the two bistable positions of the actuator 304. For example, any small amount of absorbed or desorbed fluid 306 by the absorption material 301 may result in an uneven weight distribution in the lever 307, and the lever 307 may pivot to its alternative position based on the weight differential. This may result in the one or more containers 305 moving frequently between the cool area 302 and the hot area 303 and/or the one or more containers 305 only absorbing and/or desorbing a small amount of the fluid 306 during each cycle.

In some situations, it may be desirable that the containers 305 (and the absorption material 301) remain in the cool area 302 and/or the hot area 303 until the absorption and/or desorption of the fluid 306 has occurred to a larger degree. To this end, in some embodiments, the actuator 304 includes a fulcrum offset 309. The fulcrum offset 309 may define a distance at which the center of mass 310 of the lever 307 is positioned or separated from the fulcrum 308. In this way the lever 307 may not pivot about the center of mass 310, but may pivot such that the center of mass 310 moves from one side of the fulcrum 308 to the other based on the pivoting of the lever 307 between the two bistable positions. This may correspond with the lever 307 remaining in each of the bistable positions until a larger amount of absorption and/or desorption of the fluid 306 takes place. For example, due to the fulcrum offset 309, the lever 307 may not pivot due to any unequal weight distribution, but may only pivot once the weight differential between the ends of the lever 307 has reached a threshold amount. In this way, the actuator 304 (e.g., the fulcrum offset 309) may be configured and or tuned in order to maximize an amount of absorption and/or desorption of the fluid 306 by the absorption material 301 (e.g., in the one or more containers 305 at the ends of the lever 307).

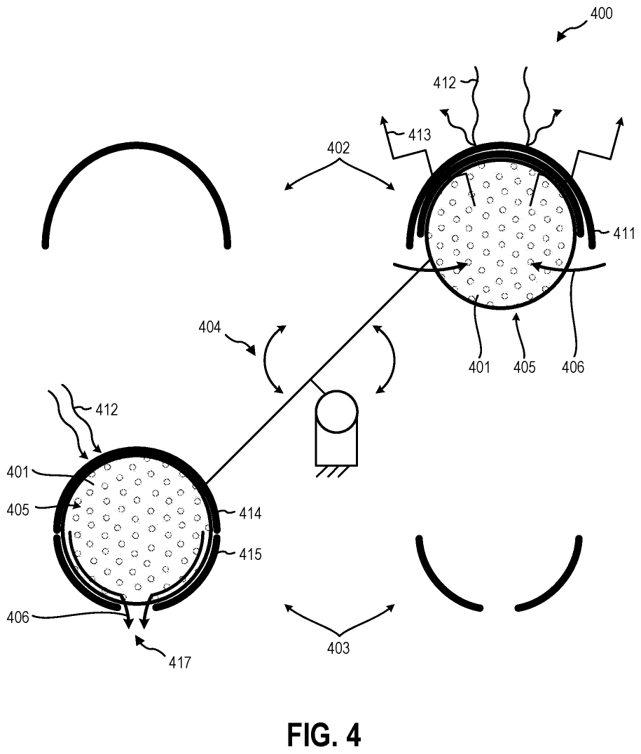

FIG. 4 is a side view of a fluid harvesting device 400, according to at least one embodiment of the present disclosure. In some embodiments, the fluid harvesting device 400 includes an absorption material 401 for absorbing and/or desorbing a fluid 406, one or more containers 405 housing the absorption material 401, and an actuator 404 for facilitating the movement of the one or more containers 405 (and the absorption material 401) between a cool area 402 and a hot area 403 of the fluid harvesting device 400. The containers 405 may be cylindrical with one or more open ends in order provide exposure (at least partly) of the absorption material 401 to an ambient environment, such as the containers 205 of FIGS. 2-1 and 2-2. The containers 405 may be any other shape in accordance with that discussed herein.

As just mentioned, the fluid harvesting device includes a cool area 402. The cool area 402 may be associated with absorption of the fluid 406 by the absorption material 401. For example, the cool area 402 may be cooled or chilled, and the absorption material 401 may be configured to absorb (e.g., more effectively and/or more efficiently) the fluid 406 when the absorption material 401 is positioned in the cool area 402.

The cool area 402 may include a thermal shield 411. The thermal shield 411 may (at least partially) facilitate the cooling of the cool area 402. For example, the thermal shield 411 may at least partially surround or enclose the container 405 and/or the absorption material 401 (e.g., when the absorption material 401 is positioned in the cool area 402). In some embodiments, the thermal shield 411 reflects one or more forms (e.g., wavelengths) of electromagnetic radiation. For example, the thermal shield 411 may reflect ultraviolet radiation, visible light, infrared radiation, microwave radiation, radio wave radiation, any other wavelength of electromagnetic radiation, and combinations thereof. In some embodiments, the thermal shield 411 is transparent to one or more forms (e.g., wavelengths) of electromagnetic radiation. For example, the thermal shield 411 may be transparent to ultraviolet radiation, visible light, infrared radiation, microwave radiation, radio wave radiation, any other wavelength of electromagnetic radiation, and combinations thereof. The thermal shield may include a passive radiative cooling film that may reflect one or more forms of radiation while being transparent to one or more other forms of radiation. In this way, the thermal shield 411 may shield the cool area 402 from one or more forms of radiation while allowing other forms of radiation to penetrate (e.g., from or out of) the cool area 402.

In accordance with at least one embodiment of the present disclosure, the thermal shield 411 may reflect solar radiation in the visible light range, or visible light 412, and may be transparent to infrared radiation 413. This may facilitate cooling the cool area 402 at least to some degree. For example, the thermal shield 411 may reflect visible light 412 that may cause matter located in the cool area 402 (e.g., the absorption material 401) to warm or heat up. The thermal shield 411 may be transparent to infrared radiation that matter such as the absorption material 401 naturally radiates. In this way, the natural radiation of matter located in the cool area 402 may cause the matter to cool off (e.g., by radiating out through the thermal shield 411 and to the upper atmosphere) and the thermal shield 411 may prevent the matter from warming by shielding it from solar radiation such as visible light 412. In other words, the thermal shield 411 may prevent the natural radiative cooling effect from being overpowered by the warming effect of visible solar radiation. In this way, the thermal shield 411 may facilitate cooling the cool area 402 without the use of a (e.g., powered) cooling system such as a chiller, air conditioner, evaporative cooler, etc. Accordingly, the thermal shield 411 may facilitate cooling the cool area 402 without the use of any external energy input such as electricity. In this way, the thermal shield 411 may cool the cool area 402, for example, to facilitate the absorption material 401 absorbing the fluid 406 when the absorption material 401 is positioned in the cool area 402.

In some embodiments, the visible light 412 that the thermal shield 411 reflects is electromagnetic radiation with wavelengths in a range having an upper value, a lower value, or upper and lower values including any of 350 nm, 400 nm, 450 nm, 500 nm, 550 nm, 600 nm, 650 nm, 700 nm, 750 nm, or any value therebetween. For example, the thermal shield 411 may reflect electromagnetic radiation with a wavelength of less than 750 nm. In another example, the thermal shield 411 may reflect electromagnetic radiation with a wavelength of greater than 350 nm. In yet another example, the thermal shield 411 may reflect electromagnetic radiation with a wavelength between 350 nm and 750 nm. In some embodiments, it is critical that the thermal shield 411 reflect electromagnetic radiation with wavelengths between 350 and 750 nm in order to facilitate cooling the cool area 402 by reflecting all wavelengths of visible light.

In some embodiments, the thermal shield 411 reflects a portion or a percentage of the visible light 412 in a range having an upper value, a lower value, or upper and lower values including any of 50%, 60%, 70%, 80%, 90%, 100%, or any value therebetween. For example, the thermal shield 411 may reflect less than 100% of the visible light 412. In another example, the thermal shield 411 may reflect greater than 50% of the visible light 412. In yet another example, the thermal shield 411 may reflect between 50% and 100% of the visible light 412. In some embodiments, it is critical that the thermal shield reflect at least 95% of the visible light 412 in order to facilitate cooling the cool area 402.

In some embodiments, the thermal shield 411 is transparent to the infrared radiation 413 with wavelengths in a range having an upper value, a lower value, or upper and lower values including any of 0.75 μm, 1 μm, 5 μm, 10 μm, 15 μm, 20 μm, 50 μm, 100 μm, 200 μm, 500 μm, 1000 μm, or any value therebetween. For example, the thermal shield 411 may be transparent to the infrared radiation 413 with wavelengths of less than 1000 μm. In another example, the thermal shield 411 may be transparent to the infrared radiation 413 with wavelengths of greater than 0.75 μm. In yet another example, the thermal shield 411 may be transparent to the infrared radiation 413 with wavelengths between 0.75 μm and 1000 μm. In some embodiments, it is critical that the thermal shield 411 is transparent to the infrared radiation 413 with wavelengths between 10 μm and 20 μm in order to facilitate cooling the cool area 402.

As mentioned above, the fluid harvesting device 400 includes a hot area 403. The hot area 403 may be associated with a desorption of the fluid 406 by the absorption material 401. For example, the hot area 403 may be heated or warmed, and the absorption material 401 may be configured to desorb (e.g., more effectively and/or more efficiently) the fluid 406 when the absorption material 401 is positioned in the hot area 403.

In some embodiments, the hot area 403 includes a heater 414. In some embodiments, the heater 414 is included as part of (e.g., connected to) the hot area 403. In some embodiments, the heater 414 is included as part of (e.g., connected to) the container 405 as shown in FIG. 4, and may become active or may generate heat when the container 405 is in the hot area 403. In this way, the heater 414 may be associated with the hot area 403 while not necessarily being connected to the hot area 403 (e.g., the heater 414 of FIG. 4 may move into and out of the hot area 403). In some embodiments, the heater continuously generates heat. In some embodiments, the heater 414 periodically generates heat, such as when the absorption material 401 is in the hot area 403 or the cool area 402.

The heater 414 may be a solar heater. For example, the heater 414 may generate heat and/or may heat up based on being exposed to solar radiation such as visible light 412 and/or any other form of solar radiation. The heater 414 may include one or more surfaces configured to absorb solar thermal energy. The one or more surfaces may have one or more features such as surface colors (e.g., dark or black) and/or surface textures (and/or any other feature) that facilitate the heater 414 absorbing and/or generating heat. The heater 414 may include one or more features for directing solar radiation at or towards the heat-absorbing surfaces of the heater 414. For example, the heater 414 may include one or more lenses, reflectors (e.g., mirrors) or any other means for directing solar radiation, and combinations thereof. In some embodiments, as shown in FIG. 4, the heater 414 (e.g., the heat-generating surface) at least partially surrounds the container 405 and/or the absorption material 401.

The heater 414 may be configured to heat some or all of the absorption material 401 (and/or the container 405). For example, when the absorption material 401 is positioned in the hot area 403, the heater 414 may heat the absorption material 401 based on the absorption material 401 (and/or the container 405) coming into contact or coming into a close proximity with the heater 414. In some embodiments, the heater 414 heats the absorption material 401 by becoming active when the absorption material 401 (and/or the container 405) is positioned in the hot area 403. For example, as shown in FIG. 4, the heater 414 may be defined by a dark surface at least partially surrounding (e.g., a top portion of) the container 405 and/or the absorption material 401. The heater 414 may not be exposed to the visible light 412 (e.g., sunlight) when in the cool area 402 (e.g., due to the thermal shield 411) and therefore may not heat the container 405 and/or the absorption material 401 when in the cool area 402. When the container 405 is positioned in the hot area 403, the heater 414 may be exposed to and may absorb the visible light 412 (e.g., sunlight) to generate heat, thereby heating the container 405 and/or the absorption material 401 when in the hot area 403. In this way, the heater 414 may heat or may provide heat in the hot area 403, for example, to facilitate the absorption material 401 desorbing the fluid 406 when the absorption material 401 is positioned in the hot area 403.

In some embodiments, the heater 414 includes a thermal mass. The thermal mass may include and/or may be made of a material with a high heat capacity. This may facilitate the thermal mass absorbing and/or taking in a large amount of thermal energy (e.g., from visible light 412), in order to heat up and/or radiate heat for a sustained period of time. In this way, the thermal mass may be a heated reservoir and may facilitate a continual and/or sustained operation of the fluid harvesting device 400. For example, as discussed herein, the heater 414 (and in turn the fluid harvesting device 400) may be operated based on solar energy such as the visible light 412. In order to operate the fluid harvesting device 400, for example, when the sun is not shining such as at night or on a cloudy day, it may be necessary to operate the heater 414 based on an additional or alternative source of thermal energy. The thermal mass may facilitate operating the fluid harvesting device 400 in such situations. For example, the thermal mass may be exposed to the visible light 412 (e.g., sunlight) during the day and may heat up. The high heat capacity of the thermal mass may allow the thermal mass to radiate heat throughout some or all of the night (or other time when the sun does not shine) in order to operate the heater 414 and/or drive the processes of the fluid harvesting device 400. The thermal mass may be any material with a high heat capacity, and may be selected based on a requirement of the system for the heater 414 to provide heat. In this way, the heater 414 including a thermal mass may facilitate operating the fluid harvesting device 400 continually, or for a sustained period of time when there is little or no access to sunlight.

In some embodiments, the heater 414 is heated at least in part from waste heat. For example, waste heat from one or more objects, facilities, processes, etc., exterior to the fluid harvesting device 400 may be transferred to the heater 414 to generate heat. This waste heat may be in addition to, or as an alternative to, other heat generation mechanisms of the heater 414 discussed herein. For example, the heater 414 may include one or more solar heating components to provide heat, for example, during the day, and the waste heat may be transferred to heater 414 to provide heat, for example during the night or any other time when solar radiation is not available. In some embodiments, the waste heat is from a datacenter. In some embodiments, the waste heat is used to heat a thermal mass of the heater 414. In this way, the heater 414 may be configured to provide and/or generate heat through a variety of different heating mechanisms.

In some embodiments, the hot area 403 includes a condenser 415. The condenser 415 may at least partially surround or encompass the container 405 and/or the absorption material 401, for example, when the container 405 is in the hot area 403. The condenser 415 may include one or more surfaces upon which the fluid 406 may condense. The condenser 415 may have one or more surfaces that are cooled or chilled, for example, below an ambient temperature and/or below a temperature of the heater 414 and/or the absorption material 401. In this way, the absorption material 401 may desorb and/or release the fluid 406 in the hot area 403 (e.g., based on the heater 414 heating the absorption material 401), and the fluid 406 may condense and/or collect on the one or more cooled surfaces of the condenser 415. In some embodiments, the absorption material 401 desorbs the fluid 406 as a gas phase of the fluid 406, such as by evaporating, or facilitating the evaporation of the fluid 406 from the absorption material 401.

In some embodiments, the condenser 415 includes a passive radiative cooling film, such as that discussed herein in connection with the thermal shield 411. The film of the condenser 415 may reflect some forms of radiation (e.g., visible light 412) while allowing other forms of radiation (e.g., infrared radiation 413) to pass through the film. This may cause the condenser 415 (e.g., one or more surfaces of the condenser 415) to radiate heat and become cooled without being heated, for example, by the visible light 412. This may result in an overall cooler surface than one or more other portions and/or components of the hot area 403. In this way, the condenser 415 may be a passive condenser and may facilitate condensing the fluid 406 released and/or desorbed from the absorption material 401 without the use of any external energy input such as electricity.

In some embodiments, the fluid 406 condensed by the condenser 415 is collected. The fluid 406 may flow or may be directed to one or more collection points 417. The condenser 415 may include and/or may be configured with one or more collection features such as channels, holes, passages, conduits, any other collection features, and combinations thereof in order to direct (e.g., based on gravity) the condensed fluid 406 out of the condenser 415 and/or the hot area 403 and to the collection point 417, where it may be collected. For example, as discussed herein, the fluid 406 may condense on one or more cooled surfaces of the condenser 415 (e.g., as droplets of the fluid 406). Gravity may cause droplets of the fluid 406 to run down the surfaces of the condenser 415 and through the collection features to the collection point 417 where it may be collected.

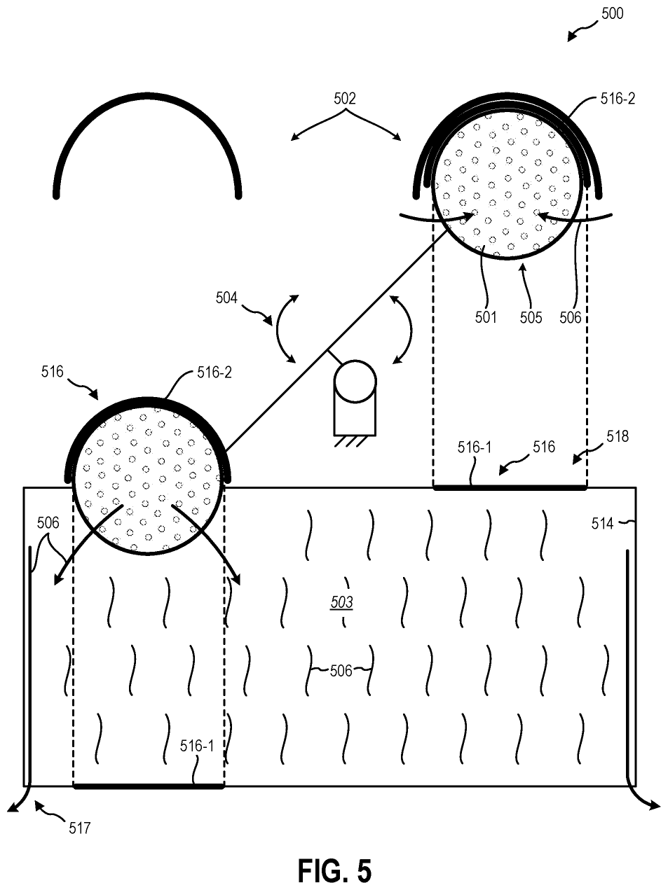

In some embodiments, the container 405 and/or the absorption material 401 (and/or the hot area 403 as discussed below in connection with FIG. 5) are sealed. For example, the condenser 415 and the heater 414 may interface or engage to seal at least a portion of the container 405 (e.g., when the container 405 is positioned in the hot area 403). This may facilitate collecting the fluid 406 condensed by the condenser 415 as discussed herein. For example, sealing the container 405 may help to contain the fluid 406 released (e.g., evaporated) from the absorption material 401 in the hot area 403 so that it may be condensed and collected by the condenser 415. In contrast, if the container 405 and/or the hot area 403 are not sealed, some or all of the fluid 406 desorbed from the absorption material 401 may escape to the ambient environment resulting in only collecting a portion of the fluid 406 absorbed and/or desorbed by the absorption material 401.

FIG. 5 is a side view of a fluid harvesting device 500, according to at least one embodiment of the present disclosure. In some embodiments, the fluid harvesting device 500 includes an absorption material 501 for absorbing and/or desorbing a fluid 506, one or more containers 505 housing the absorption material 501, and an actuator 504 for facilitating the movement of the one or more containers 505 (and the absorption material 501) between a cool area 502 and a hot area 503 of the fluid harvesting device 500.

In some embodiments, the hot area 503 is sealed, or is configured to be sealed. This may facilitate containing and/or collecting the fluid 506 in the hot area 503. For example, the hot area 503 may define an (at least partially) enclosed volume. As the fluid 506 is desorbed (e.g., evaporated) from the absorption material 501, it may be contained within the enclosed volume of the hot area 503. This may be in contrast to, for example, the fluid 506 escaping to the ambient environment. In this way, the hot area may be at least partially filled with the fluid 506, for example, in a gas phase.

In some embodiments, a condenser 514 (at least partially) defines the enclosed volume of the hot area 503. For example, one or more surfaces of the enclosed volume may include or may be made of a passive radiative cooling film as discussed herein. The film may exhibit a lower temperature than one or more other portions and/or components of or associated with the hot area 503. The cool surfaces of the film may facilitate the (e.g., gas phase) of the fluid 506 condensing on the film (e.g., as droplets of the fluid 506). Droplets of the fluid 506 may run down the surfaces of the condenser 514 (e.g., the film) and to one or more collection points 517 of the condenser 514 and/or the hot area 503. For example, the condenser 514 and/or the hot area 503 may include one or more collection features such as channels, holes, passages, conduits, any other collection features, and combinations thereof for directing the fluid 506 to the collection points 517. In this way, the fluid 506 may be desorbed from the absorption material 501 and collected.

The hot area 503 (or more specifically the enclosed volume of the hot area 503) may be configured to allow the one or more containers 505 to pass (partially or completely) into and/or out of the hot area 503, in conjunction with the movement of the container 505 by the actuator 504. For example, the hot area 503 may include one or more openings 518. The openings may be sized, oriented, or otherwise configured (and combinations thereof) such that the containers 505 and/or the absorption material 501 may be (at least partially) positioned in and/or exposed to the hot area 503.

The hot area 503 may be configured to seal the enclosed volume in order to prevent the fluid 506 from escaping. To this end, one or more seals 516 may be associated with the hot area 503. The seal 516 may be a door, a plug, a membrane, or any other sealing element (and combinations thereof). The seal 516 may seal one or more of the openings 518 (e.g., to seal the enclosed volume) and may be configured to move or otherwise open to allow one or more of the containers 505 to (at least partially) enter and/or be positioned in the hot area 503. The seal 516 may be configured to move or otherwise close, for example, when the one or more containers 505 leaves the hot area 503. For example, the seal 516 may be configured with a spring, counterweight, compliant material and/or mechanism, or other biasing device to bias the seal 516 toward a closed position, and the seal 516 may move, open, or close based on the movement of the container 505 from the cool area 502 to or toward the hot area 503 (or vice versa). In another example, the seal 516 may be connected to and or associated with the container 505, and may move based on a movement of the container 505.

In accordance with at least one embodiment of the present disclosure, the fluid harvesting device 500 may include one or more first seals 516-1 and one or more second seals 516-2. Each of the first seals 516-1 and the second seals 516-2 may be connected to and/or associated with one or more of the containers 505 such that the first seals 516-1 and the second seals 516-2 may move based one or with a movement of the containers 505. For example, as shown in FIG. 5, the first seal 516-1 may seal the opening 518 based on the container 505 being positioned in the cool area and/or based on the container 505 moving out of the hot area 503. As the container 505 moves toward the hot area 503, the first seal 516-1 may move and/or open to allow the container 505 to enter and/or be exposed to the hot area 503. Similarly, the second seal 516-2 may seal the opening 518 based on the container 505 being positioned in the hot area 503 and/or based on the container 505 moving out of the cool area 502. As the container 505 moves out of or away from the hot area 503, the second seal 516-2 may move and/or open to allow the container to leave and/or exit the hot area 503. In some embodiments, the second seal 516 is (or may be at least partially part of) a heater configured to heat the container 505 and/or the absorption material 501 (such as the heater 414 of FIG. 4). In this way, the first seal 516-1 and the second seal 516-2 may seal the enclosed volume of the hot area 503 in order to facilitate collecting the fluid 506.

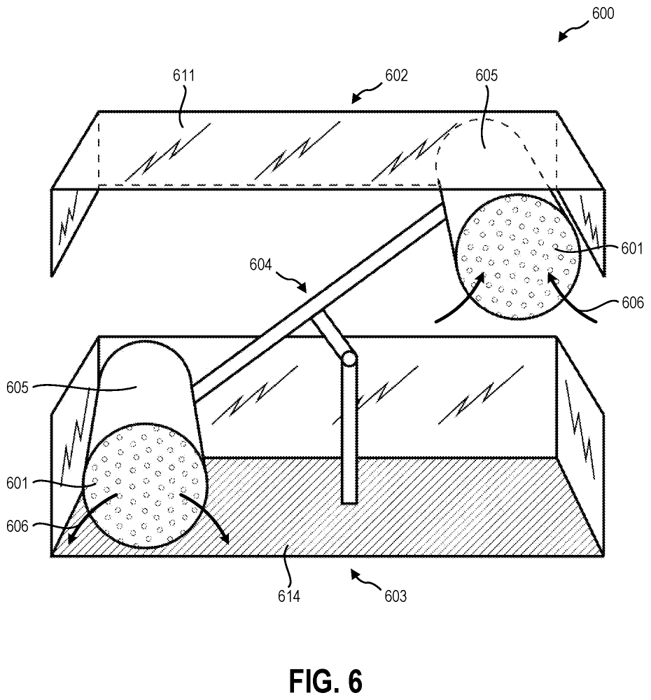

FIG. 6 is a perspective cutaway view of a fluid harvesting device 600, according to at least one embodiment of the present disclosure. In some embodiments, the fluid harvesting device 600 includes one or more containers 605 for holding and/or housing an absorption material 601 for absorbing and/or desorbing a fluid 606. The fluid 606 may be absorbed by the absorption material 601 in a cool area 602 (e.g., when the container 605 is positioned in the cool area 602), for example from an ambient environment. The cool area 602 may include (or may be at least partially made of) a thermal shield 611 such as a passive radiative cooling film as discussed herein. In some embodiments, the cool area 602 defines a partially enclosed volume. For example, one or more containers 605 may be configured to be positioned (e.g., periodically) in the partially enclosed volume of the cool area 602 while still being exposed to an ambient environment. In this way, the containers 605 and/or the absorption material 601 may be cooled in the cool area 602 and may absorb the fluid 606 from the ambient environment.

In some embodiments, an actuator 604 moves or facilitates the movement of the one or more containers 605 (and the absorption material 501) between the cool area 602 and a hot area 603 of the fluid harvesting device 600. The fluid 606 may be desorbed from the absorption material 601 in the hot area 603 (e.g., when the container 605 is positioned in the hot area 603). For example, a heater 614 may be positioned in the hot area 603 such that the container 605 may come into contact or close proximity with the heater 614. This may cause the container 605 and/or the absorption material 601 to heat up, which may facilitate the desorption of fluid 606 from the absorption material 601. The hot area 603 may be the hot area 503 of FIG. 5. For example, the hot area 603 may include a top surface and one or more sealing features in order to create or define an enclosed volume of the hot area 603 to facilitate collecting the fluid 606 that is desorbed from the absorption material 601 in the hot area 603.

In some embodiments, the heater 614 is a solar heater. The heater 614 may include one or more features such as surface colors (e.g., dark or black) and/or surface textures (and/or any other feature) that facilitate the heater 614 absorbing and/or generating heat. The heater may include one or more features for directing solar radiation at or toward the heat-absorbing surfaces of the heater 614. For example, the heater 614 may include one or more lenses, reflectors (e.g., mirrors) or any other means for directing solar radiation, and combinations thereof. In some embodiments, the heater 614 is positioned at a bottom of the hot area 603. This may facilitate the heater being exposed to and/or absorbing solar energy. In some embodiments, the heater includes a thermal mass, or a material with a high heat capacity. The thermal mass may absorb a large amount of heat and may radiate heat for a sustained period of time. In this way, the thermal mass may facilitate the heater 614 functioning for a sustained period of time (or continuously), for example, with little or no access to solar radiation.

In some embodiments, the heater 614 is configured to generate heat based on waste heat being transferred to the heater. For example, waste heat from a source exterior to the fluid harvesting device 600 (e.g., a datacenter) may be transferred to the heater 614 to heat the heater 614 in addition to, or as an alternative to, the one or more heat generating mechanisms of the heater 614 discussed herein (such as solar heating). In some embodiments, the waste heat heats a thermal mass of the heater 614. In this way, waste heat may provide (at least some) of the heating effect of the heater 614, periodically and/or continually.

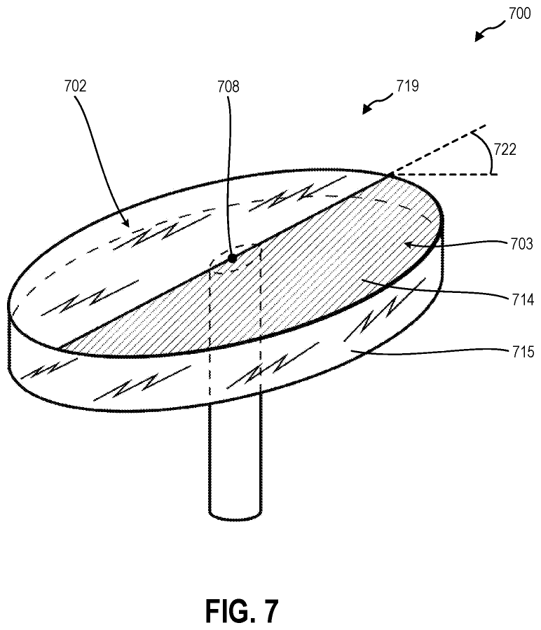

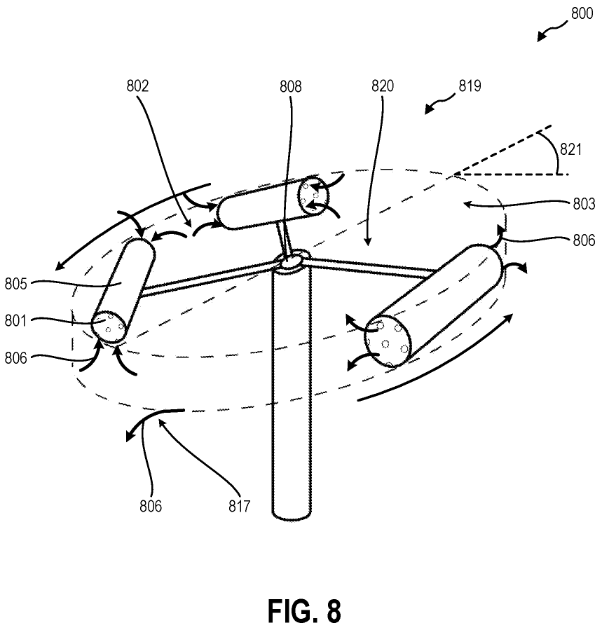

FIG. 7 is a perspective view of a fluid harvesting device 700, according to at least one embodiment of the present disclosure. In some embodiments, the fluid harvesting device 700 includes an enclosure 719. The enclosure 719 may have a substantially round dimension and/or may be substantially cylindrical. The enclosure 719 may be any other shape in accordance with the techniques described herein. In some embodiments, the enclosure 719 is at least partially hollow and/or defines an inner volume. For example, the enclosure 719 may substantially be a hollow cylinder. The hollow, inner volume of the enclosure 719 may facilitate positioning one or more containers housing an absorption material inside or within the enclosure 719. As will be discussed herein in connection with FIGS. 7 and 8, the absorption material (and the containers) may be included as part of a rotor that may be configured to rotate within the enclosure 719. For example, the rotor may pivot and/or rotate about an axis 708. In this way, the absorption material may rotationally move within the enclosure 719 and cycle through one or more portions or areas of the enclosure 719. This may facilitate the fluid harvesting techniques described herein.

In some embodiments, the enclosure 719 includes a cool area 702. The cool area 702 may be an area of the enclosure that is configured to cool or chill, for example, a container and/or an absorption material positioned in the cool area 702. The cool area 702 may include and/or may be made of a passive radiative cooling film as discussed herein. For example, one or more surfaces of a top, a side, and a bottom of the cool area 702 may include the film in order that the volume inside of the cool area 702 may be naturally and/or passively cooled (e.g., by reflecting solar radiation and allowing infrared radiation to pass through). In this way, a container and/or an absorption material positioned in (or rotating through) the cool area 702 may be cooled, at least to some degree, by the radiative cooling effect provided by the film.

The cool area 702 may be configured to provide exposure to an ambient environment. For example, the cool area 702 may include one or more openings, slots, holes, passages, etc., in one or more of the surfaces of the cool area 702 in order that ambient air may pass into and out of the cool area 702. In some embodiments, a side and/or a bottom of the cool area 702 is open or may not be covered in the film (or any other material) in order to facilitate providing exposure to the ambient environment. In this way, absorption material positioned in (or passing through) the cool area may be exposed to the ambient environment, for example, in order that the absorption material may absorb a fluid (e.g., water vapor) from or out of the ambient environment. In some embodiments, the cooler temperature of the cool area 702 may facilitate and/or enhance the absorption material absorbing the fluid from the ambient environment. In this way, the cool area 702 may be associated with and/or may facilitate the absorption material absorbing fluid.

In some embodiments, the enclosure 719 includes a hot area 703. The hot area 703 may be an area of the enclosure 719 that is configured to heat or warm, for example, a container and/or an absorption material positioned in the hot area 703. For example, the hot area 703 may include a heater 714. The heater 714 may at least partially encompass the hot area 703, or may at least partially surround an inner volume of the enclosure 719 associated with the hot area 703. For example, the heater 714 may be positioned on one or more of a top, a side, and a bottom of the hot area 703. The heater 714 may be a solar heater as described herein. The heater 714 may be configured to absorb solar radiation and heat up, thereby heating the volume inside of the hot area 703. In this way, a container and/or an absorption material positioned in (or rotating through) the hot area 703 may be heated, at least to some degree, by the heater 714. The warmer temperature of the hot area 703 may facilitate and/or enhance the ability of the absorption material to desorb the fluid that it absorbed in the cool area 702. In some embodiments, the heater 714 includes a thermal mass, such as a material with a high heat capacity. This may facilitate operation of the heater 714 (and the fluid harvesting device 800) when there is little or no access to thermal radiation (such as at night). In some embodiments, waste heat from an external source is provided to heat the heater 714, such as from a datacenter. This may be in place of or may be supplemental to (e.g., periodically or continuously) other heating mechanisms of the heater 714 described herein. In some embodiments, the waste heat heats a thermal mass of the heater 714. In this way, the hot area 703 may facilitate the absorption material releasing and/or desorbing fluid.

In some embodiments, the hot area 703 includes a condenser 715. The condenser 715 may be defined by one or more surfaces of the hot area 703 that are cooled, or exhibit a colder temperature than one or more other surfaces and/or components of the hot area 703 and/or the ambient environment. For example, one or more surfaces of the hot area 703, such as a top, a side, or a bottom (or combinations thereof) may include a passive radiative cooling film, as discussed herein. The film may naturally exhibit a lower temperature than one or more other components of the hot area 703 and may facilitate the fluid (that is desorbed from the absorption material in the hot area 703) condensing on the surfaces of the film and/or condenser 715. The hot area 703 and/or the condenser 715 may include one or more collection features for directing the condensed fluid (e.g., via gravity) toward a collection point so that it may be collected.

In some embodiments, the hot area 703 (and/or the inner volume of the enclosure 719 associated with the hot area 703) is at least partially sealed. For example, the hot area 703 may be sealed from the cool area 702. One or more seals may be positioned at an opening of the hot area 703 such that one or more containers may enter (and/or pass through) the hot area 703 and the hot area 703 may remain sealed. This may facilitate capturing and/or collecting the fluid desorbed from the absorption material and/or may prevent the desorbed fluid from escaping to the ambient environment.

In some embodiments, the enclosure 719 has an offset angle 722. The offset angle 722 may be an angle (e.g., measured from horizontal) by which the enclosure 719 is tilted or angled. The offset angle 722 of the enclosure 719 may be the same or may be different than an offset angle of rotor that rotates inside of the enclosure 719, as discussed herein. In some embodiments, the enclosure 719 does not have an offset angle 722 and/or may be substantially horizontal. In some embodiments, the enclosure 719 includes one or more features to accomplish the functions of the offset angle 722 described herein without the (e.g., entire) enclosure 719 being offset, such as one or more sloped features of the shape of the enclosure 719.

The offset angle 722 may facilitate one or more functions of the fluid harvesting techniques describe herein. For example, the offset angle 722 may facilitate collecting the fluid condensed by the condenser 715. A collection point may be located at a lower portion of the enclosure (e.g., a lower portion of the hot area 703 and/or the condenser 715) and the fluid condensed by or condensed on the surfaces of the condenser 715 may be directed toward the collection point due to gravity.

In another example, the offset angle 722 may facilitate heating the hot area 703 and/or cooling the cool area 702. The heater 714 and/or the radiative cooling film may have an optimal or maximum effectiveness and/or efficiency based on an angle of interaction with, for example, solar radiation (e.g., visible light). The offset angle 722 may accordingly be adjusted and/or tuned in order to improve the effectiveness and/or efficiency of one or more components of the fluid harvesting device 700.

FIG. 8 is a perspective view of a fluid harvesting device 800, according to at least one embodiment of the present disclosure. In some embodiments, the fluid harvesting device 800 includes an enclosure 819 (such as the enclosure 719 of FIG. 7) with a cool area 802 and a hot area 803.

In some embodiments, the fluid harvesting device 800 includes a rotor 820. The rotor 820 may be configured to rotate within an inner volume of the enclosure 819 about an axis 808. The rotor 820 may include one or more containers 805. The containers 805 may be positioned at a radially outer position of the rotor 820 such that the containers 805 rotate about a circular path concentric with the axis 808. In this way, as the rotor 820 rotates, the containers 805 move and/or cycle through the cool area 802 and the hot area 803.

As discussed herein, the containers 805 may hold or may house an absorption material 801 for reversibly absorbing a fluid 806. For example, the absorption material 801 may absorb the fluid 806 from an ambient environment when the container 805 is positioned in the cool area 802, and may desorb the fluid 806 from the absorption material 801 when the container 805 is positioned in the hot area 803. The container 805 may include one or more features which may expose (at least partially) the absorption material 801 to an environment (e.g., air) outside of the container 805. For example, the container 805 may include one or more openings or holes such as one or more open ends and/or a mesh surface for facilitating the fluid 806 passing into and out of the container 805 (such as that discussed in connection with the container 205 of FIGS. 2-1 and 2-2). The fluid 806 desorbed from the absorption material 801 in the hot area 803 may be condensed by a condenser in the hot area 803 and the condensed fluid 806 may be directed (e.g., by gravity based on an offset angle of the enclosure 819) to a collection point 817 where it may be collected.

As discussed herein, the absorption and desorption of the fluid 806 by the absorption material 801 may result in a weight imbalance between one or more of the containers 805, and therefore a weight imbalance in the rotor 820. This weight imbalance may drive the rotation of the rotor 820 and the containers 805 based on gravitational forces. For example, the rotor may have an offset angle 821. The offset angle 821 may be an angle (e.g., measured from horizontal) by which the rotor 820 is titled or angled. The offset angle 821 may be the same or different than an offset angle that the enclosure may have (e.g., offset angle 722 of FIG. 7).

The offset angle 821 may result in the circular path that the containers 805 follow having one or more areas of a higher vertical position as well as one or more areas of a lower vertical position. Based on the offset angle 821, as well as the orientation of the hot area 803 and the cool area 802 with respect to the offset angle 821, one or more containers 805 positioned in an area having a higher vertical position may become heavier and gravity may act on these containers 805 causing them to fall or travel downwards to an area having a lower vertical position. One or more containers 805 positioned in an area having a lower vertical position may become lighter, adding to this effect. In some embodiments, the rotor 820 includes a plurality of containers positioned and/or spaced around a periphery or circumference of the rotor 820. This may result in at least some portion of the rotor 820 continually being driven downwards due to gravity, which may drive a continual rotation of the rotor 820 and the containers 805. In this way, the rotor 820 and the containers 805 may be driven to rotate through the enclosure 819 without the use of any external energy input such as electricity. In some embodiments, the rotor 820 rotates without being driven by a motor. In some embodiments, one or more motors may be implemented in one or more other components of the fluid harvesting device 800 apart and/or independent from the rotor 820 rotating without being driven with and/or by a motor. The fluid harvesting device 800 may operate in this way for a sustained period, or even continually.

The speed at which the rotor 820 rotates through the enclosure 819 (and in turn the amount of time that the absorption material remains in the cool area 802 and/or the hot area 803) may be determined or may be based on the offset angle 821. For example, a larger offset angle 821 (e.g., a steeper tilt of the rotor 820) may result in the weight differential driving a faster rotation of the rotor 820. In another example, a smaller offset angle 821 (e.g., a flatter tilt of the rotor 820) may result in the weight differential driving a slower rotation of the rotor 820. In some situations, it may be desirable that the absorption material remain in the cool area 802 long enough to become substantially loaded with the fluid 806 and/or that the absorption material remain in the hot area 703 long enough to become substantially unloaded of the fluid 806. The offset angle 821 (and accordingly a speed of rotation of the rotor 820) may correspond to and/or may be selected based on an optimal or working duration for the absorption fluid to remain in the cool area 802 and/or the hot area 803. In this way, the offset angle may be adjusted and/or configured to tune and/or optimize an operation of the fluid harvesting device 800.

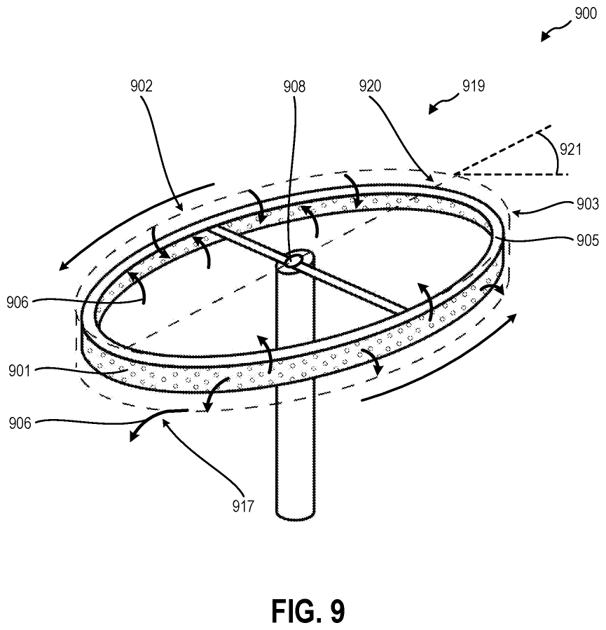

FIG. 9 is a perspective view of a fluid harvesting device 900, according to at least one embodiment of the present disclosure. In some embodiments, the fluid harvesting device 900 includes an enclosure 919 (such as the enclosure 719 of FIG. 7) with a cool area 902 and a hot area 903.

In some embodiments, the fluid harvesting device 900 includes a rotor 920. The rotor 920 may be configured to rotate within an inner volume of the enclosure 919 about an axis 908. The rotor 920 may include one or more containers 905. The containers 905 may be one continuous container or maybe segmented into multiple containers. The container(s) 905 may form the shape of a wheel, a ring, an annulus, a toroid, a disk, any other shape according to the techniques described herein, and combinations thereof. The container 905 may be hollow and/or may have hole, passage, or bore through an inner portion of the container 905. The container 905 may not have an inner bore and/or may not be ring-shaped, but may be a substantially continuous volume such as a disk or a cylinder. The container 905 may be positioned at least partially at a radially outer position of the rotor 920 such that the container 905 rotates about a circular path concentric with the axis 908. In this way, as the rotor 920 rotates, discrete portions of the container 905 move and/or cycle through the cool area 902 and the hot area 903, portion by portion.

As discussed herein, the container 905 may hold or may house an absorption material 901 for reversibly absorbing a fluid 906. For example, the absorption material 901 may absorb the fluid 906 from an ambient environment when the absorption material 901 is positioned in the cool area 902, and may desorb the fluid 906 from the absorption material 901 when the absorption material 901 is positioned in the hot area 903. The fluid 906 desorbed from the absorption material 901 in the hot area 903 may be condensed by a condenser in the hot area 903 and the condensed fluid 906 may be directed (e.g., by gravity based on an offset angle of the enclosure 919) to a collection point 917 where it may be collected.

The container 905 may be configured such that the absorption material may be exposed (as least partially) to an environment (e.g., air) outside of the container 905. The container 905 may include one or more holes or openings in one or more surfaces of the container 905. For example, an inside surface and/or an outside surface of the container 905 (e.g., of a ring-shaped or similar shaped container 905) may be partially or entirely covered with openings such that the absorption material 901 is contained within the container 905 while allowing the fluid 906 to pass into and out of the container 905 (and into/out of the absorption material 901). In another example, an inside surface and/or an outside surface of the container 905 may be partially or completely open, and the container 905 may include inner structure features such as a grid structure, a honeycomb structure, or any other arrangement or matrix (and combinations thereof) to contain the absorption material 901 while allowing the fluid 906 to pass through to the absorption material 901. In another example, one or more open surfaces of the container may include a mesh or lattice to contain the absorption material 901 in the container 905. In some embodiments, these techniques and/or features are implemented on a top surface and/or a bottom surface of the container 905. This may be in addition to or in place of implementing the features on the inside and/or outside surfaces of the container 905.

In this way, the container 905 may be and/or may function similarly to a thermal wheel, rotary heat exchanger, rotary air-to-air enthalpy wheel, and/or Kyoto wheel. For example, the container 905 may be a continuous body and may accordingly house a continuous pool or bed of the absorption material 901. The container 905 may continually rotate (e.g., slowly) through the enclosure 919 and cyclically expose the absorption material 901 to the hot area 903 and the cool area 902, portion by portion. This may be in contrast to, for example, some embodiments described herein where an entire container of the absorption material is cycled between areas. In this way, the container 905 may facilitate implementing a larger volume of the absorption material 901 which may increase an efficiency and/or effectiveness of the fluid harvesting device 900.

Similar to that discussed above in connection with FIG. 8, the rotation of the rotor 920 may be driven by gravitational forces acting on a weight differential of the container 905 and/or the rotor 920. For example, the rotor 920 may have an offset angle 921. The offset angle 921 may be the same or different than an offset angle that the enclosure may have (e.g., offset angle 722 of FIG. 7). The offset angle 921 may result in the circular path that the container 905 follows having one or more areas of a higher vertical position as well as one or more areas of a lower vertical position. Based on the offset angle 921, as well as the orientation of the cool area 902 and the hot area 903 with respect to the offset angle 921, portions of the absorption material 901 positioned in an area having a higher vertical position may become heavier and gravity may act on these portions causing them to fall down to an area having a lower vertical position. Portions of the absorption material 901 positioned in an area having a lower vertical position may become lighter, adding to this affect. As discussed herein, the container 905 and the absorption material 901 may be continuous (e.g., substantially or semi-continuous) around a periphery or circumference of the rotor 920, and at least a portion of the rotor 920 may therefore be continuously driven downwards due to gravity, which may drive a continual rotation of the rotor 920 and the container 905. In this way, the rotor 920 and the container 905 may be driven to rotate through the enclosure 919 without the user of any external energy input such as electricity. In some embodiments, the rotor 920 rotates without being driven by a motor. In some embodiments, one or more motors may be implemented in one or more other components of the fluid harvesting device 900 apart and/or independent from the rotor 920 rotating without being driven with and/or by a motor. The fluid harvesting device 900 may operate in this way for a sustained period, or even continually.

The speed at which the rotor 920 rotates through the enclosure 919 (and in turn the amount of time that the absorption material remains in the cool area 902 and/or the hot area 903) may be determined or may be based on the offset angle 921. For example, a larger offset angle 921 (e.g., a steeper tilt of the rotor 920) may result in the weight differential driving a faster rotation of the rotor 920. In another example, a smaller offset angle 921 (e.g., a flatter tilt of the rotor 920) may result in the weight differential driving a slower rotation of the rotor 920. In some situations, it may be desirable that the absorption material remain in the cool area 902 long enough to become substantially loaded with the fluid 906 and/or that the absorption material remain in the hot area 903 long enough to become substantially unloaded of the fluid 906. The offset angle 921 (and accordingly a speed of rotation of the rotor 920) may correspond to and/or may be selected based on an optimal or working duration for the absorption fluid to remain in the cool area 902 and/or the hot area 903. In this way, the offset angle may be adjusted and/or configured to tune and/or optimize an operation of the fluid harvesting device 900.

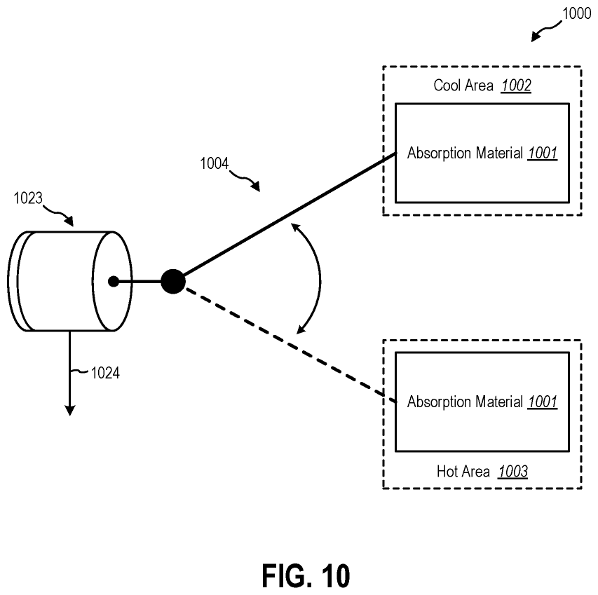

FIG. 10 is a schematic representation of a fluid harvesting device 1000, according to at least one embodiment of the present disclosure. In some embodiments, the fluid harvesting device 1000 includes an absorption material 1001 configured to absorb and desorb a fluid, for example from an ambient environment. In some embodiments, the fluid harvesting device 1000 includes a cool area 1002. The cool area 1002 may exhibit a cooler temperature than, for example, an ambient environment or than a hot area 1003 of the fluid harvesting device 1000. The cool area 1002 may be associated with and/or may facilitate the absorption material 1001 absorbing fluid. In some embodiments, the fluid harvesting device 1000 includes a hot area 1003. The hot area 1003 may exhibit a hotter temperature than, for example, an ambient environment or than the cool area 1002. The hot area 1003 may be associate with and/or may facilitate the absorption material 1001 desorbing fluid.

In some embodiments, the fluid harvesting device 1000 includes a positioner 1004. The positioner 1004 may position the absorption material 1001 in the cool area 1002 and/or the hot area 1003, or may move the absorption material 1001 between the cool area 1002 and the hot area 1003 (and vice versa). In some embodiments, the fluid harvesting device 1000 includes a motive device 1023. The motive device 1023 may be connected to and/or may be operatively associated with the positioner 1004. In some embodiments, the motive device 1023 (at least partially) drives the positioner 1004. For example, the motive device 1023 may move or drive the positioner and/or may assist the positioner 1004 in moving the absorption material 1001. The motive device 1023 may be a motor (e.g., an electric motor or a combustion motor) or any other motive device for converting and/or applying an external energy input (e.g., external from the fluid harvesting device 1000) to a motion and/or a movement of the positioner 1004. In this way, the energy harvesting device 1000 may be operated, at least partly, based on an external energy source.

In some embodiments, the energy harvesting device 1000 operates independent of or without any external energy input (e.g., apart from a solar thermal energy input to heat a heater of the hot area 1003 as discussed herein). For example, as discussed herein the positioner 1004 may operate and/or may be driven based on a gravity and/or based on gravitational forces acting on a weight differential associated with the absorption material 1001. For example, at least a portion of the cool area 1002 may be positioned vertically higher than at least a portion of the hot area 1003. The absorption material 1001 may become heavier as it absorbs fluid in the cool area 1002 and may be driven by gravity to or towards the hot area 1003.

In some embodiments, the motive device 1023 is coupled to the positioner 1004 and may convert and/or apply the movement of the positioner 1004 as an energy output 1024. For example, the motive device 1023 may be an electrical motor and/or a generator, and may generate an electrical energy output 1024 (e.g., an electrical current) based on the movement of the positioner 1004. The motive device 1023 may convert and/or apply the movement of the positioner 1004 as any other form of energy output 1024, such as any type of mechanical motion or energy. In some embodiments, some or all of the energy output 1024 is transmitted out of the system of the fluid harvesting device 1000, such as stored externally as electrical energy or used to drive some other function and/or process of some other external device or system. In some embodiments, some or all of the energy output 1024 is transmitted or used within the system of the fluid harvesting device 1000. For example, the energy output 1024 may be used to cool the cool area 1002, heat the hot area 1003, drive a pump for pumping the fluid harvested by the fluid harvesting device 1000, any other function, and combinations thereof.

The motive device 1023 may be implemented in connection with both the lever-operated embodiments as well as the rotor-operated embodiments of the fluid harvesting device 1000 described herein to generate the energy output 1024. In this way, the fluid harvesting device 1000 may not only operate without any (external) energy consumption, but may generate energy or may operate at a net negative (external) energy consumption (e.g., have a net positive energy output).

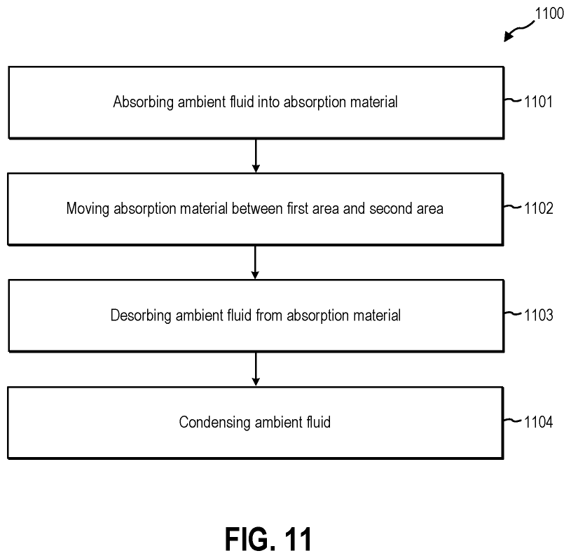

FIG. 11 illustrates a flow diagram for a method 1100 or a series of acts for harvesting ambient fluid as discussed herein, according to at least one embodiment of the present disclosure. While FIG. 11 illustrates acts according to one embodiment, alternative embodiments may omit, add to, reorder, or modify any of the acts shown in FIG. 11.

In some embodiments, the method 1100 includes an act 1101 of absorbing ambient fluid into an absorption material. For example, the absorption material may be included as part of a fluid harvesting device, and may absorb the ambient fluid as absorbed ambient fluid. In some embodiments, the ambient fluid is water vapor, and the absorption material removes the water vapor from ambient air. In some embodiments, the absorption material has an electrostatic attraction to the ambient fluid. In some embodiments, the absorption material absorbs up to 10 times its weight in the ambient fluid. The absorption material may absorb the ambient fluid in a first area of the fluid harvesting device. Absorbing the ambient fluid in the first area may include cooling the first area, and the first area of the fluid harvesting device may be a cool area. Cooling the first area may include radiating heat from the absorption material through a thermal shield and to the upper atmosphere. The thermal shield may be transparent to electromagnetic radiation with wavelengths of 10-20 micrometers.

In some embodiments, the method 1100 includes an act 1102 of moving the absorption material between the first area of the fluid harvesting device and a second area of the fluid harvesting device. For example, the fluid harvesting device may move the absorption material based on a weight differential. In some embodiments, the weight differential is a weight differential of the absorption material. For example, the weight differential of the absorption material may be based on absorbing a first portion of the ambient fluid to the absorption material and desorbing a second portion of the ambient fluid from the absorption material. In some embodiments, the fluid harvesting device moves the absorption material without electricity.

In some embodiments, the method 1100 includes an act 1103 of desorbing ambient fluid from the absorption material. For example, the fluid harvesting device may desorb at least a portion the absorbed ambient fluid from the absorption material as desorbed ambient fluid. The absorbed ambient fluid may be desorbed from the absorption material in the second area of the fluid harvesting device. Desorbing the absorbed ambient fluid in the second area may include heating the second area, and the second area of the fluid harvesting device may be a hot area. Heating the second area may include absorbing solar thermal radiation with a heater.

In some embodiments, the method 1100 includes an act 1104 of condensing the ambient fluid. For example, the fluid harvesting device may condense at least a portion of the desorbed ambient fluid as condensed ambient fluid. In some embodiments, the method includes collecting at least a portion of the condensed ambient fluid.

### INDUSTRIAL APPLICABILITY

The present disclosure includes a number of practical applications having features described herein that provide benefits and/or solve problems associated with harvesting fluid from an ambient environment. Some example benefits are discussed herein in connection with various features and functionalities provided by a fluid harvesting device. It will be appreciated that the benefits explicitly discussed in connection with one or more embodiments described herein are provided by way of example and are not intended to be an exhaustive list of all possible benefits of the fluid harvesting device and further are not intended to limit the scope of the claims.

For example, fluid harvesting devices in accordance with the techniques described herein may be implemented in a variety of locations, environments, climates, etc. A particular application or implementation of the fluid harvesting device may necessitate a certain size, shape, and/or configuration. The fluid harvesting device described herein is scalable and the functionality and/or effectiveness of the device may scale proportionally (e.g., linearly) to the size of the device. In this way, the fluid harvesting device may be implemented in both large-scale and small-scale applications, or any size therebetween.

In addition to being configurable for implementation in a wide variety of applications, the systems, methods, and devices described herein are generally operable based on basic principles and may be implemented simply and economically. For example, absorption materials such as that described herein may be obtained relatively inexpensively. As another example, the techniques described herein do not require any energy (e.g., electricity) input to operate. This may be in contrast to some conventional device which often require (sometimes large amounts of) electricity, for example, to operate condensers, compressors, heaters, motors, etc. In this way, the fluid harvesting device may be economical to implement.

Additionally, the techniques described herein may be implemented for sustained or even continual operation. For example, the fluid harvesting device described herein may perform many cycles throughout a day and may even continue to operate at night. This may be in contrast to some conventional techniques which may operate only one cycle per day and/or may not function at all at night (or other times when the sun does not shine). This sustained and/or continual operation may facilitate the fluid harvesting device described herein collecting a larger amount of fluid than, for example, conventional devices.

Further, at least one embodiment of the fluid harvesting device describe herein may be implemented to harvest water from an ambient environment or from the air. In many areas of the world, water can be scarce and/or clean water may be difficult to obtain. The techniques of the present disclosure may provide an inexpensive, simple, and easy-to-implement solution for turning water vapor from the air into a reliable source of clean, usable water. The present device may not require any energy input and may have no cost to operate, further facilitating the implementation of the fluid harvesting device in many areas of the world in need of water resources.

The following non-limiting examples are illustrative of the various permutations contemplated herein.

A1. A device for harvesting ambient fluid, comprising:
a cool area;
a hot area;
an absorption material configured to absorb ambient fluid; and
means for moving the absorption material between the cool area and the hot area based on a weight differential of the absorption material.

A2. The device of A1, wherein at least a portion of the cool area is positioned higher than at least a portion of the hot area.

A3. The device of A1 or A2, wherein the cool area is at least partially exposed to an ambient environment.

A4. The device of any of A1-A3, wherein the hot area includes one or more collection features for directing condensed ambient fluid to a collection point.

A5. The device of A4, further comprising a condenser for condensing at least a portion of the ambient fluid.

A6. The device of A5, wherein the condenser includes one or more cooled surfaces for condensing the ambient fluid.

A7. The device of A5, wherein the condenser is associated with the hot area.

A8. The device of any of A5-A7, wherein the condenser includes a passive radiative cooling film.

A9. The device of any of A1-A8, wherein the hot area is sealed from an ambient environment.

A10. The device of any of A1-A9, wherein the means for positioning the absorption material include a bistable lever.

A11. The device of A10, wherein the bistable lever includes a fulcrum offset.

A12. The device of A10, wherein the bistable lever does not pivot about its center of mass.

A13. The device of any of A1-A12, wherein the means for positioning the absorption material include an angled rotor.

A14. The device of A13, further including an enclosure that at least partially encloses the angled rotor such that the angled rotor rotates within the enclosure.

A15. The device of A14, wherein the enclosure includes the hot area and the cool area and the angled rotor rotates through the hot area and the cool area.

A16. The device of any of A1-A15, wherein the means for moving the absorption material operates without any external energy input apart from solar thermal energy to heat the hot area.

A17. The device of any of A1-A16, wherein the means for moving the absorption material is not driven with a motor.

A18. The device of any of A1-A17, wherein the means for moving the absorption material operates without electricity.

B1. A method of harvesting ambient fluid comprising:
in a first area, absorbing the ambient fluid into an absorption material as absorbed ambient fluid;
moving the absorption material between the first area and a second area based on a weight differential;
in the second area, desorbing at least a portion of the absorbed ambient fluid from the absorption material as desorbed ambient fluid; and
condensing at least a portion of the desorbed ambient fluid as condensed ambient fluid.

B2. The method of B1, further comprising collecting at least a portion of the condensed ambient fluid.

B3. The method of B1 or B2, wherein the weight differential is a weight differential of the absorption material.

B4. The method of any of B1-B3, wherein the weight differential is based on a first portion of the ambient fluid condensing into a first portion of the absorption material and a second portion of the ambient fluid evaporating from a second portion of the absorption material.

B5. The method of any of B1-B4, wherein moving the absorption material includes moving the absorption material without an external energy input apart from a solar thermal radiation input to heat the second area.

B6. The method of B5, wherein the absorption material is not moved by a motor.

B7. The method of B5, wherein moving the absorption material includes moving the absorption material without using electricity.

B8. The method of any of B1-B7, wherein absorbing the ambient fluid in the first area includes cooling the first area.

B9. The method of B8, wherein cooling the first area includes reflecting at least 95% of visible light from at least a portion of the first area with a shielding film.

B10. The method of B9, wherein cooling the first area includes causing infrared electromagnetic radiation to radiate from at least a portion of the first area through the thermal shield.

B11. The method of B10, wherein the thermal shield is transparent to electromagnetic radiation with wavelengths of 10-20 micrometers.

B12. The method of B8, wherein cooling the first area includes radiating heat from the absorption material to the upper atmosphere.

B13. The method of any of B1-B12, wherein desorbing the absorbed ambient fluid in the second area includes heating the second area.

B14. The method of B13, wherein heating the second area includes heating a reservoir of high heat capacity material positioned in the second area.

B15. The method of B13, wherein heating the second area includes absorbing solar thermal radiation with a heater.

B16. The method of B13, wherein the second area is heated at least in part by waste heat from an external source.

B17. The method of B16, wherein the waste heat is from a datacenter.

B18. The method of any of B1-B17, wherein the ambient fluid is water vapor.

B19. The method of any of B1-B18, wherein the absorption material is a material configured to reversibly absorb the ambient fluid.

B20. The method of any of B1-B19, wherein the absorption material has an electrostatic attraction to the ambient fluid.

B21. The method of any B1-B20, wherein the absorption material is a hydrophilic material.

B22. The method of any of B1-B21, wherein the absorption material absorbs up to 10 times its weight in the ambient fluid.

C1. A system for generating energy, comprising:
a first area including a thermal shield having a film transparent to electromagnetic radiation with wavelengths of 10-20 micrometers and reflective to at least 95% of visible light;
a second area including a solar heater;
an absorption material for reversibly absorbing water vapor from an ambient environment;
an actuator configured to move the absorption material based on an absorption of the water vapor into the absorption material in the first area and a desorption of the water vapor from the absorption material in the second area; and
a motive device configured to generate an energy output based on the movement of the actuator.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A device for harvesting ambient fluid, comprising:
a cool area;
a hot area;
an absorption material configured to absorb ambient fluid; and
a means for moving the absorption material between the cool area and the hot area based on a weight differential of the absorption material.

2. The device of claim 1, wherein at least a portion of the cool area is positioned vertically higher than at least a portion of the hot area.

3. The device of claim 1, wherein the cool area is at least partially exposed to an ambient environment.

4. The device of claim 1, wherein the hot area is sealed from an ambient environment.

5. The device of claim 1, further comprising a condenser for condensing at least a portion of the ambient fluid.

6. The device of claim 1, wherein the hot area includes one or more collection features for directing condensed ambient fluid to a collection point.

7. The device of claim 1, wherein the means for positioning the absorption material include a bistable lever and/or an angled rotor.

8. A method of harvesting ambient fluid comprising:
in a first area, absorbing the ambient fluid into an absorption material as absorbed ambient fluid;
moving the absorption material between the first area and a second area based on a weight differential;
in the second area, desorbing at least a portion of the absorbed ambient fluid from the absorption material as desorbed ambient fluid; and
condensing at least a portion of the desorbed ambient fluid as condensed ambient fluid.

9. The method of claim 8, further comprising collecting at least a portion of the condensed ambient fluid.

10. The method of claim 8, wherein the weight differential is a weight differential of the absorption material based on absorbing a first portion of the ambient fluid to the absorption material and desorbing a second portion of the ambient fluid from the absorption material.

11. The method of claim 8, wherein moving the absorption material includes moving the absorption material without electricity.

12. The method of claim 8, wherein absorbing the ambient fluid in the first area includes cooling the first area.

13. The method of claim 12, wherein cooling the first area includes radiating heat from the absorption material through a thermal shield and to the upper atmosphere.

14. The method of claim 13, wherein the thermal shield is transparent to electromagnetic radiation with wavelengths of 10-20 micrometers.

15. The method of claim 8, wherein desorbing the absorbed ambient fluid in the second area includes heating the second area.

16. The method of claim 15, wherein heating the second area includes absorbing solar thermal radiation with a heater.

17. The method of claim 8, wherein the ambient fluid is water vapor.

18. The method of claim 8, wherein the absorption material has an electrostatic attraction to the ambient fluid.

19. The method of claim 8, wherein the absorption material absorbs up to 10 times its weight in the ambient fluid.

20. A system for generating energy, comprising:
a first area including a thermal shield having a film transparent to electromagnetic radiation with wavelengths of 10-20 micrometers and reflective to at least 95% of visible light;
a second area including a solar heater,
an absorption material for reversibly absorbing water vapor from an ambient environment;
an actuator configured to move the absorption material based on an absorption of the water vapor into the absorption material in the first area and a desorption of the water vapor from the absorption material in the second area; and
a motive device configured to generate an energy output based on the movement of the actuator.
